(19) United States
(12) Patent Application Publication
(10) Pub. No.: US 2024/0408789 A1
(43) Pub. Date: Dec. 12, 2024

(54) PRESS MOLDING METHOD OF A CUP SHAPED FIBER PRODUCT, A FIBER PRESS MOLD AND A CUP SHAPED FIBER PRODUCT

(71) Applicant: Blue Ocean Closures AB, Karlstad (SE)

(72) Inventor: Lars Sandberg, Hammarö (SE)

(73) Assignee: Blue Ocean Closures AB, Karlstad (SE)

(21) Appl. No.: 18/699,053

(22) PCT Filed: Oct. 6, 2022
(86) PCT No.: PCT/SE2022/050896

§ 371 Date: Apr. 5, 2024

(30) Foreign Application Priority Data
Oct. 6, 2021 (SE) 2151225-6

(51) Int. Cl. B27N 5/02; B31F 1/00

(52) U.S. Cl. CPC B27N 5/02; B31F 1/0077

(57) ABSTRACT

A fiber capsule and a method of compression molding a fiber-based packaging capsule, includes the steps: a raw capsule of a loosely bonded fiber mat is formed, which capsule has an opening; the raw capsule of the loosely bonded fiber mat is positioned on the inside of a substantially rigid mold having inner surfaces defining the molded outer surfaces of the fiber-based packaging capsule; the loosely bonded fiber mat is compression molded by the insertion of a pressurizable compression member through the opening. The pressing device is pressurized at a temperature of 150-250 degrees C.°. The compression molding takes place by reshaping the reshaping pressing device and pressing the inside of the capsule against the inner surfaces of the rigid mold so that a cohesive fiber-based packaging capsule is obtained.

### TECHNICAL FIELD

This invention relates to a press molding method of a cup shaped fiber product, at high pressure and high temperature, by means of a press pad device and a stamp device, wherein said cup shaped fiber product comprises a bottom part, side walls and an edge part and a fiber press mould for performing the method.

### TECHNICAL BACKGROUND

A cup shaped fiber product can be made by pressing a web or a sheet of fibers. Typically, a combination of natural fibers (e.g. wood pulp fibers), synthetic fibers (e.g. polyoliphene based fibers) and other additives such as binder or dye. In many applications it is preferred that such a web essentially merely comprises of natural fiber, with or without additives. Typical process conditions are 150-250 C and pressures 100-10000 bar (200-2000 Bar). Moisture content may typically be less than 20%.

Fiber products can be in the form of a hollow product, for example a package or a closure (lid, screw cap or similar), but can also be a flat product. Products can be formed from a web of the material and punched/cut in connection with forming, e.g. that have been completely or partially separated from the web to allow deeper shaping. This exposure is typically done by cutting the material into a shape that is adapted to the final shape. Typically, for example, a roundel is cut to form a round package.

The press molding typically takes place with two tools where both the outer tool pad and the inner tool (stamp) can consist of several parts to enable discharge of the finished product. Typically, the pad opens while the stamp collapses. The piston, parts of the piston or parts of the pad can also be made of a compressible material which enables greater vertical compressive forces, typically against the sides of the cavity, by the tool material being reshaped during the compression.

When the product is formed, the upper edge will typically be uneven due to the material being folded while being pressed into the tool. The uneven material can be cut away horizontally or vertically after forming or during the forming itself. In both cases, cutting residues are formed which must be handled in production and ideally recycled. If cutting in the same operation as pressing, the design of the upper part of the tool is limited in that the edge of the two parts must be adapted to the cutting machining. This can cause difficulties in feeding the material into the pad. Cutting in the same operation as pressing also causes problems with pressing the material with a sufficiently high force at the same time as it is cut. Therefore, the cut edge may consist of poorly shaped material. Examples of known methods described above are shown in EP 3 736 099 and WO 2020/165780.

From CN-20132641774 there is known a manufacturing mould for production of plate shaped pulp products having a smooth outer edge. The mould comprises a convex press pad device, a central concave stamp device, and an annular outer stamp device, wherein the outer stamp device is used to form a smooth outer edge.

### SUMMARY OF THE INVENTION

It is an object of the invention to eliminate or at least minimize the disadvantages mentioned above, which is a achieve by a method as defined in claim 1 and/or a fiber press mould as defined in claim 13 and/or a fiber product as defined in claim 14.

Thanks to the invention cutting after press molding of cup shaped products may be completely avoided. In addition to eliminate the need of further cutting and eliminating a need of taking care of leftovers, the invention may also achieve a better product in that the quality of the edge of product may be more or less tailored, e.g. providing a higher quality in the edge portion.

### DESCRIPTION OF FIGURES

In the following, the invention will be described with reference to a preferred embodiment of a schematic pressing mould and method according to the invention by schematically describing the manufacture of the specific preferred example, in which:

FIG. 1 shows a schematic cross-sectional view of a press mould in a first stage of producing a cup shaped cylindrical fiber product,

FIG. 2 shows a schematic cross-sectional view of a press mould in a second stage of producing a cup shaped cylindrical fiber product, and,

FIG. 3 shows the same schematic cross-sectional view as FIG. 2, but with a pressing mould arranged with grooves for cup shaped cylindrical fiber product having threads.

### DETAILED DESCRIPTION

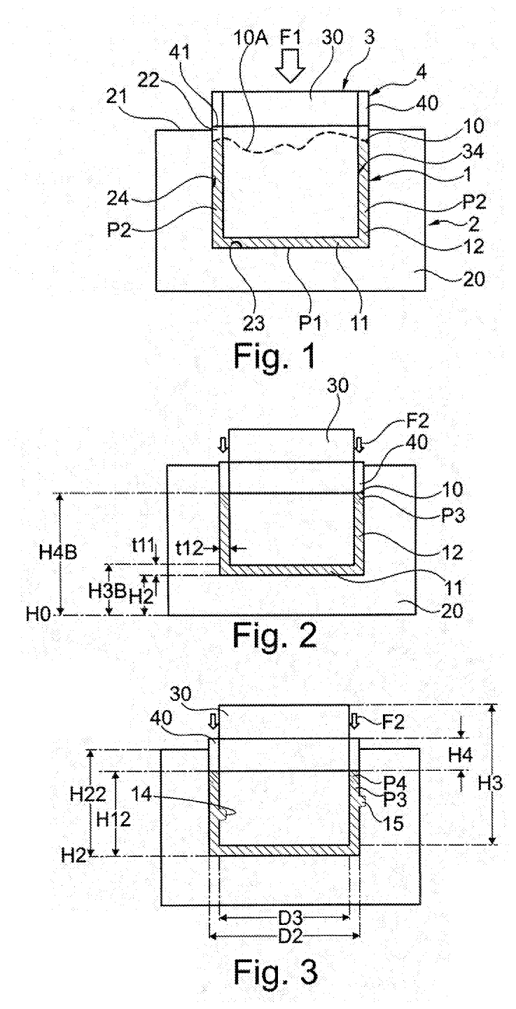

In FIGS. 1 and 2 there is shown a fiber press mould, comprising a press pad device 2 and a stamp device, for forming a fiber product 1. The stamp device comprises two stamp members 3,4, wherein a first stamp member 3 is arranged to form at least a bottom part 11 of said fiber product 1 and a second stamp member 4 is arranged to form the edge part 11 of said fiber product. In the shown embodiment the second stamp member 4 is movable along the outer periphery of said first stamp member 3.

The press pad device 2 comprises a body 20, having a total height H2. The press pad device 2 is arranged with a cavity 22. In this embodiment the cavity is relatively large in order to enable a cup shaped fiber product 1, i.e. comprising vertical side walls 12 between the edge part 10 and the bottom part 11. Hence the cavity 22 comprises a bottom surface 23 and vertical sidewalls 24, which in this embodiment is formed by a ring shaped, cylindrical surface. The total height H22 of the cavity 22, i.e. from the bottom surface 23 of the cavity, that extends horizontally, to the upper surface 21 of the body 20, is arranged such that it is larger than the height H12 of the fiber product 1. Preferably H2 is at least 10% larger than H12, more preferred at least 15% larger.

The first stamp member 3 comprises a body 30 adapted to fit into the cavity 22 such that a gap may be formed between the vertical side surface 34 thereof and the vertical sidewalls 24 of the cavity 22, whereby a desired thickness t12 of the side walls 12 of the fiber product 1 may be achieved. This is achieved by having a cross-sectional measure D2 of the cavity 22 that is two times t12 larger than the cross-sectional measure D3 of the first stamp member 3. It is evident for the skilled person within the field that the definition “vertical” must be understood as substantially vertical, i.e. including shapes where the sidewalls 12 (one or both of the surfaces thereof) may deviate some few degrees from being exactly 90° in relation to the horizontal plane of the bottom part 11.

In the shown embodiment, where a product 1 with circular form is produced, this is achieved by using a circular shape of the side walls 24, 34 forming the cross-sectional measures in the form of diameters D2 and D3, respectively. As is understood by the skilled person other shapes than exactly circular may of course be used, e.g. merely along the side walls 24 of the of the press pad device 2. The second stamp member 4 has a ring-shaped body 40 arranged to slide along the outer surface 34 of the first stamp member 3 and may have a height H4 that is smaller than the height H3 of the first stamp member 3. An end surface 41 of the ring-shaped body 40 will be forming the edge part 10 of the fiber product 1.

When using the mould for press molding of the fiber product 1, a pre-cut blank (not shown per se) is introduced into the cavity 22 of the press pad device 2. The height H22 of the cavity 22 is such that the entire pre-cut blank may be positioned within the cavity 22, i.e. such that no parts of the pre-cut blank protrude above the upper surface 21 of the press pad device 2. In a first step the first stamp member 3 is applied with a force F1 to move down into the cavity 22 and will then push the pre-cut blank into the cavity 22 and form an intermediate product 1A having an uneven upper edge 10A, see FIG. 1. The height H22 of the cavity 22 is such that all parts of the uneven upper edge 10A may be positioned below the upper surface 21 of the press pad device 2.

Subsequently the second stamp member 4 is applied with a force F2 to move along the outer side surface 34 of the first stamp member 3, to be forced down into the cavity 22 in the gap formed between the outer side surface 34 of the first stamp member 3 and the walls 24 of the cavity. High temperature is used during production and high pressure is applied by means of the press pad device 2 and the stamp device 3,4, to form the fiber product 1. The molding temperature may be in the range of 150-250° C. and the applied pressure by the stamps 3, 4 is at least 200 bar. In some applications it is preferable to use a force F2 that will produce a higher pressure P3 within the edge part 10 of the product than the pressure P2 that is produced by the force F1 applied to the first stamp member 3.

As is shown, the first stamp member 3 forms at least the bottom part 11 of the fiber product 1 and the second stamp member 4 forms the edge part 10. This basic principle may also be used on a flat shaped fiber product. Preferably the first stamp member 3 at least partly forms at least said bottom part 11 before said second stamp member 4 starts forming said edge part 10.

Preferably the arrangement is such (e.g. sensor controlled) that the first stamp member 3 stops pressing at a given distance H3B in relation to a position H0 of the press pad device 2 and the second stamp member 4 stops pressing at a given distance H4B in relation to that position H0 of the press pad device 2. Of course, this latter position may also be set in relation to the first stamp member 3. Most preferred the end position of the first stamp member 3 is such that pressing stops at a given distance H4B in relation to a position H0 of said press pad device 2 such that a given thickness t11 is achieved for said bottom part 11.

As shown in the figures the fiber product 1 may comprise substantially vertical sidewalls 12 wherein the second stamp member 4 stops at a given distance H4B, at a set distant H12 from said bottom part 11, such that the edge part 10 is positioned such that a desired height H12 of the product 1 is achieved. As already mentioned above the second stamp member 4 may be applied with a force F2 producing a pressure P3 within the upper edge part 10 that differs from pressure P2 produced by the first stamp member 3, which may provide advantages. In many applications it may be an advantage that the second stamp member 4, is applied to produce a higher pressure P3 than the pressure P2 exerted from the first stamp member 3. This may be especially advantageous if the edge part 10 is to be given a pattern or a profile, and/or if the portions of the side walls 12, below the edge part 10, is to be given a pattern or a profile, e.g. protruding profiles inwardly 14 and/or outwardly 15, e.g. forming threads and/or a rim as indicated in FIG. 3.

Further, as indicated in FIG. 3 the force F2 applied by the second stamp member 4 may achieve a higher pressure P4 near the edge part 10 than the pressure P3 achieved further down within the side walls 12, below the edge part 10, due to resilient properties of the fibers.

Thanks to the invention a great flexibility is provided regarding production of fibre products, e.g. to achieve a higher density in the edge part 10 than in the bottom part 11. A higher local density at the edge part may reduce the ability for penetration of moisture and liquid. Further it facilitates easy production of an edge part having a desired appearance, e.g. straight even faces. Moreover, it facilitates easy production of side walls arranged with protruding members, e.g. threads and/or ribs, etc. the material consists partly of natural fibers, A.

Preferably the fiber material in the fiber product 1 is in the form of natural fibers from wood. Further, the amount of water in pre-cut blank (e.g. roundel) prior to pressing shall not exceed 20% the weight of fiber.

Further, by designing the mould tool so that an entire pre-cut blank may be pressed down into the pad 2 and below the upper end surface of the pad 2 and the form the upper edge part 11, a product with a given height and volume of material may be created. The secondary pressing may achieve the desired result despite having fibers that have been relocated during the pressing with the first stamp member 3. Hence, the final product may successfully be achieved despite slightly varying density in the upper edge part 11 without any problems regarding creasing and/or local differences in the upper edge of the preformed product. In particular, the post-forming can beneficially compress side walls of a cup shaped product, by applying a relatively small force P2 onto a limited horizontal surface compared to the force P1, that is applied by means of the first stamp member 3. The second stamp member can be seen as creating a kind of reshaping, which may also assist in shaping inward or outward formations with a varying gap thickness or shape such as, for example, embossments, stiffeners or threads as in FIG. 3.

An additional benefit is that by means of the invention the shaping of faces having precise patterns or profiles may be achieved, i.e. shapes that are not possible to achieve if cutting is needed to shape the final product.

According to a modification of the invention (not shown) the second stamp member 4 can be arranged to cut off a non-desired part (not shown) of the final fiber product 1, e.g. at a given distance from said bottom part. Preferably this is performed such that first the pressing edge 41 of the second stamp 4 first compresses the edge 10, at least partly, and that a cutting edge (not shown) of the second stamp in a final step both finally compresses the edge 10 and cuts off a non-desired surplus.

1. A press molding method of forming a fiber product, at high pressure and high temperature, by means of a press pad device and a stamp device, wherein a pre-cut blank is used that prior to pressing has a water content not exceeding 20% the weight of fiber to produce said fiber product and said fiber product comprises a bottom part, side walls and an edge part, wherein said stamp device comprises two stamp members, wherein a first stamp member forms at least said bottom part and a second stamp member forms said edge part, wherein said second stamp member stops at a given distance distant from said bottom part having said edge part positioned farthest distant from said bottom part (11), and wherein said second stamp member is movable along the outer periphery of said first stamp member, and by having an upper edge of said fiber product after forming at least said bottom part positioned within a cavity of said press pad device.

2. Press molding method according to claim, 1 wherein said sidewalls extend vertically in relation to a horizontal plane including said bottom part.

3. Press molding method according to claim, 1 wherein said first stamp member at least partly forms at least said bottom part before said second stamp member starts forming said edge part.

4. Press molding method according to claim 1, wherein all parts of said upper edge are positioned below an upper surface of the body of said press pad device.

5. Press molding method according to claim 1, wherein said second stamp member at a given distance distant from said bottom part at least partly cuts off a non-desired part of the final fiber product.

6. Press molding method according to claim 1, wherein said second stamp member stops pressing at a given distance in relation to a position of said press pad device and/or said first stamp member, such that said edge part is positioned at a given distance.

7. Press molding method according to claim 1, wherein the end position of the first stamp member stops pressing at a given distance in relation to a position of said press pad device so that a given thickness is reached for said bottom part.

8. Press molding method according to claim 1, wherein forces are applied to the first and second stamp members, such that different pressures are achieved within the edge part when merely pressing with the first stamp members compared to when also pressing with the second stamp members, wherein preferably a higher pressure is achieved when pressing with the second stamp members.

9. Press molding method according to claim 1, wherein the material consists partly of natural fibers, preferably natural fibers from wood.

10. Press molding method according to claim 1, wherein the molding temperature is 150° C. and the pressure on said bottom part is at least 200 bar.

11. (canceled)

12. Press molding method according to claim 1, wherein said edge part and/or side walls is/are given a pattern and/or a profile.

13. A fiber press mold, comprising a press pad device and a stamp device, arranged to form a fiber product comprising a bottom part and an edge part, wherein said stamp device comprises two stamp members, wherein a first stamp member is arranged to form at least a bottom part of said fiber product and a second stamp member is arranged to form said edge part of said fiber product, and wherein said second stamp member is arranged to stop at a given distance distant from said bottom part having said edge part positioned farthest distant from said bottom part, and wherein said second stamp member is arranged to move along the outer periphery of said first stamp member, wherein said second stamp member is arranged to stop at a given distance distant from said bottom part to also form sidewalls of said fiber product and an upper edge of said fiber product within a cavity of said press pad device.

14. A fiber product comprising a bottom part, vertical sidewalls and an edge part, characterized in that said edge part has a higher density than parts of a side wall closer to the bottom part than the edge part.

15. A fiber product according to claim 14, wherein portions of said side walls, between the edge part and the bottom part, have a pattern or a profile forming threads and/or a rim.
